(19) United States
(12) Patent Application Publication
(10) Pub. No.: US 2026/0108956 A1
(43) Pub. Date: Apr. 23, 2026

(54) SYSTEM FOR WORKING A WORKPIECE COMPRISING A MACHINE TOOL AND CORRESPONDING WORKING METHOD

(71) Applicant: CYBERMECA, Fontenay le Comte (FR)

(72) Inventor: Didier Ledoux, Fontenay le Comte (FR)

(73) Assignee: CYBERMECA, Fontenay le Comte (FR)

(21) Appl. No.: 19/117,668

(22) PCT Filed: Oct. 6, 2023
(86) PCT No.: PCT/FR2023/051565

§ 371 Date: Apr. 2, 2025

(30) Foreign Application Priority Data
Oct. 7, 2022 (FR) FR2210312

(51) Int. Cl. B23B 39/14; B23B 49/00

(52) U.S. Cl. CPC B23B 39/14; B23B 49/00

(57) ABSTRACT

The invention relates to a system and a method for working a workpiece (P1) using a machine tool (M1) comprising a drive shaft (400) provided with a tool holder (600) to which a tool (900) can be coupled, a drive motor (2) for rotating at least one portion of the drive shaft (400), which portion is fitted with the tool holder (600); a feed motor (3) for axially moving the drive shaft (400). A device measures a distance representative of the distance between the workpiece (P1) and the frame (100) of the machine tool. A control unit (8) is configured to execute work operations on the workpiece by controlling the drive motor and/or the feed motor; to determine a change in the axial distance between the frame of the machine tool and the workpiece resulting from relative axial movement between the workpiece and the frame. The second motor is controlled so as to axially move the drive shaft in order to compensate for the relative axial movement between the workpiece and the frame.

### FIELD OF THE INVENTION

The present invention generally relates to systems for working a workpiece comprising a machine tool.

### BACKGROUND ART

We know from the state of the art machine tools, for example for carrying out milling, trimming, drilling, threading or nut tightening operations.

We know from document U.S. Pat. No. 5,649,451 A a drilling system which includes a clamp for holding a workpiece to be worked, and a drilling machine which is configured to apply a simultaneous linear and rotary movement to the drilling tool of the machine.

The machine comprises a first motor and a second motor. The first motor comprises a rotor coupled to a ball screw engaged with a helical ring on the drive shaft so as to convert the rotational movement of the rotor into linear movement which is imparted to the drive shaft.

The second motor comprises a rotor coupled to a ball spline which engages a spline on the drive shaft so as to transmit the rotary movement of the rotor to the drive shaft directly, while allowing the drive shaft to move linearly along its axis.

However, we note that during the work, the workpiece can move, even in the held state of the workpiece, without this movement being desired by the operator. The workpiece being worked can thus move back, for example due to the tool pressing on the workpiece, which harms the quality of the work performed on the workpiece. In particular, the dimensions obtained for the area of the workpiece thus worked may not correspond to the desired dimensions.

Document GB2593501 A describes a robot which carries a machine tool comprising a drilling tool. The drilling tool comprises an axis drill.

Document US2012020756A describes a drilling/milling unit adapted to be supported by an industrial robot. The unit comprises a spindle that can rotate about an axis. An electric servomotor drives a hollow shaft axially through a belt. An electric servomotor drives the spindle through an associated belt.

The aim of the present invention is to propose a new machine tool and a corresponding working method making it possible to overcome all or part of the problems disclosed above.

### SUMMARY OF THE INVENTION

To this end, the object of the invention is a system for working a workpiece, the system comprising a machine tool which comprises:
a frame;
a drive shaft having a longitudinal axis, said drive shaft being provided with a tool holder to which a tool can be coupled, such as a drilling spindle;
a first motor, called a rotational drive motor, which is a rotary motor configured to rotate at least one portion of said drive shaft, which portion is fitted with the tool holder;
a second motor, called a feed motor, said feed motor being configured to axially move said drive shaft, and being preferably a linear motor;
   characterized in that the system also comprises a distance measuring device configured to measure a distance representative of the distance between the workpiece and the frame of the machine tool;
a control unit configured to:
execute work operations on the workpiece by controlling the rotational drive motor to rotate the tool holder, and/or by controlling the feed motor to axially move the tool holder;
determine, using the distance measuring device, a change in the axial distance between the frame of the machine tool and the workpiece to be worked resulting from a relative axial movement between the workpiece and the frame of the machine;
depending on the change in the distance determined between the machine tool and the workpiece to be worked, control the second motor so as to axially move said drive shaft to compensate for said relative axial movement between the workpiece and the frame of the machine,
   and in that the rotational drive motor and the feed motor are configured so that the axial movement of said at least one portion of the drive shaft which is fitted with the tool holder, is controllable independently of the rotation of said at least one portion of the drive shaft which is fitted with the tool holder.

The fact that the axial movement of said at least one portion of the drive shaft which is fitted with the tool holder, is controllable independently of the rotation of said at least one portion of the drive shaft which is fitted with the tool holder, means that the rotation of said at least one portion of the drive shaft has no impact on the axial movement of the drive shaft and vice versa, which makes it possible to move precisely and reliably said drive shaft to move it forward or backward in order to bring it to a new axial reference position depending on the movement of the workpiece to be worked which must be compensated.

The possibility of controlling the axial movement of the drive shaft to which the tool holder is fastened, during operation of the machine tool, makes it possible to correct the position of the tool coupled to the tool holder and thus hold the relative position of the tool holder and therefore of the tool relative to the workpiece to be worked, even in the event of relative axial movement between the workpiece to be worked and the frame of the machine tool.

The relative axial movement between the tool and the workpiece to be worked may be due to a movement of the workpiece as a whole (for example a back movement of the workpiece) or even to a deformation of the workpiece to be worked during the work it undergoes.

Taking into account the variation in relative position between the machine tool and the workpiece to be worked makes it possible to ensure a process for working the workpiece which is precise and reliable.

The compensation for the relative axial movement between the machine tool and the workpiece to be worked makes it possible in particular to achieve an effective fragmentation of the chip resulting from the work of the workpiece by the tool. It should be noted that an uncompensated relative axial movement could degrade this fragmentation of the chip, or even prevent it. The compensation for the relative axial movement also makes it possible to ensure a milling depth as required.

In document GB2593501A of the state of the art, the mobility of the drill is simply used to perform a back and forth movement for drilling, but document GB2593501A does not provide for adjusting the axial position of the drill relative to the frame of the machine tool, to obtain a new reference position of the drill relative to the frame of the machine tool, in order to compensate for a bias measured between the frame of the machine tool and the workpiece to be worked. In GB2593501A it is the robot arm itself which is moved to compensate for a bias between the workpiece and the drilling machine tool carried by the robot arm.

It is not provided in document GB2593501A to adjust the axial position of the drill relative to the frame of the machine tool to compensate for the measured bias, with, relative to the frame, an axial movement of the shaft which carries the drill, which would be controlled independently of the rotation of said shaft which carries the drill.

In document GB2593501A, moving the robot arm itself, which carries the machine tool, in an attempt to correct a bias during drilling poses problems of precision and reliability because the movement of the entire robot arm-which is heavy-is less precise than moving the drill relative to the frame by means of the feed motor.

Furthermore, this movement of the robot arm being the result of movements of several axes of the robot, the movement of the machine tool cannot be well collinear with the drilling axis being carried out on the workpiece and the quality of the tool's work is therefore impacted.

The design of the system according to the invention makes it possible to correct in real time the position of the work tool, such as a drill, while maintaining the drilling direction in the case of a drilling tool, and this in a simple and reliable manner.

In document US2012020756A, a rotation motor rotates a spindle, and the translation movement of the spindle is generated by a speed difference between the rotation motor and another motor. There is therefore no complete decoupling between the two movements of rotation and feed. For example, a slight change in the rotation speed of the rotation motor causes a slight translational movement of the spindle. In addition, in document US2012020756A, the feed movement also depends on a helical nut, a mechanical part that can be loose leading to axial positioning errors of the spindle, particularly during correction movements.

The design of the system according to the invention makes it possible to correct by the movement of a single motor, namely the feed motor, the position of the tool coupled to the tool holder carried by the drive shaft, and thus held the relative position of the tool holder and therefore of the tool relative to the workpiece to be worked, even in the event of relative axial movement between the workpiece to be worked and the frame of the machine tool, and this in precise and reliable manner and in real time.

The system may also include one or several of the following characteristics taken in any technically admissible combination.

According to one embodiment of the invention, the distance measuring device is carried by a movable part of a bearing device, called a blank holder nose, said movable part of the blank holder nose being movably mounted relative to a part which is fixed relative to the frame, the movable part being configured to bear back against the workpiece, the distance measuring device being arranged to measure the distance between the movable part and the fixed part of the blank holder nose.

According to one embodiment of the invention, the drive shaft comprises a first segment and a second segment connected together by a connecting device, one of the segments being engaged with the feed motor, the other segment being engaged with the rotational drive motor.

According to one embodiment of the invention, the drive shaft comprises a first segment and a second segment connected together by a connecting device configured to make the first segment and the second segment integral in axial movement with each other, while maintaining freedom of rotation of the first segment relative to the second segment.

According to one embodiment of the invention, the first segment to which the tool holder is fastened can be rotated by the rotational drive motor, and the second segment can be axially moved by the feed motor.

According to one embodiment of the invention, the feed motor is a linear motor having a primary part fixedly mounted relative to the frame of the machine tool, and a secondary part, movably mounted in a direction parallel to the axis of the drive shaft, which is fastened to a segment of the drive shaft, or formed integrally with said segment of the drive shaft.

According to one embodiment of the invention, the system comprises a support system, such as a polyarticulated robot, which carries the machine tool to allow the machine tool to be positioned at the desired position and orientation relative to the workpiece to be worked, the machine tool being hingedly mounted to the support system.

According to one embodiment, the support system comprises a main base (or framework) and an arm, the machine tool being hingedly mounted on the arm, said arm comprising one or several sections which can be hinged together, said arm being preferably itself hingedly mounted on the base.

According to one embodiment of the invention, the control unit is configured to allow the drive shaft to be moved in order to move the tool axially in a movement with variable speed to fragment the chip resulting from the work of the tool on the workpiece to be worked.

The invention also relates to a method for working a workpiece using a work system according to any one of the preceding embodiments, the machine tool of said work system comprising a tool holder equipped with a work tool, the method comprising the following steps:
positioning the machine tool relative to the workpiece with a view to working the workpiece using said tool; the distance between the workpiece and the frame of the machine tool being equal to a value, called an initial value, the drive shaft having an axial reference position relative to the frame of the machine tool;
executing work operations on the workpiece by controlling the rotational drive motor to rotate the tool, and/or by controlling the feed motor to axially move the tool;
   the axial movement of the tool being controlled as a function of said axial reference position of the drive shaft;
during work on the workpiece, determining a change in the distance between the workpiece and the frame of the machine, so that the distance between the workpiece and the frame of the machine tool is equal to a new value;
compensating for the movement of the workpiece by axial movement of the drive shaft of the tool holder by a distance, referred to as a compensation distance, corresponding to the difference between the new value and the initial value so as to define a new axial reference position of the drive shaft,
continuing the work operations on the workpiece as a function of the new reference position of the shaft.

According to a particular aspect, to compensate for the movement of the workpiece, the axial movement of the drive shaft is carried out while maintaining the frame of the machine tool which carries the motors, stationary in the terrestrial reference frame. It is therefore the drive shaft which moves, preferably along and inside the frame of the machine tool, and not the frame which would be moved in the terrestrial reference frame.

According to one embodiment of the invention, the rotational drive motor comprises a stator fixedly mounted relative to the frame of the machine, and a rotor which is in direct engagement with said drive shaft.

Preferably the stator comprises a winding system and the rotor comprises a magnet system so that the electrical powering of the winding system generates a magnetic field which interacts with the magnet system. The rotary motor thus generates a radial electromotive force (electromagnetic torque) which rotates at least the portion of the drive shaft with which the rotor is engaged. The electromotive force generated by the rotary motor is radial while the electromotive force generated by the feed motor is axial.

Advantageously, the secondary of the feed motor is in direct engagement with said drive shaft.

Preferably, the primary of the feed motor comprises a winding system carried by the frame and the secondary of the feed motor comprises a magnet system which is carried by a part integral with the drive shaft or which is directly integrated into the drive shaft. The electrical powering of the winding system generates a magnetic field which interacts with the magnet system.

The feed motor generates an axial electromotive force which translates the drive shaft with which the secondary of the feed motor is engaged. The electromotive force generated by the feed motor is axial while the electromotive force generated by the rotary motor is radial.

The fact of carrying the magnet system by the drive shaft and the winding system, which is heavier than the magnet system, by the frame, makes it possible not only to facilitate the wiring for the powering of the corresponding motor, but also to limit the mass to be moved, i.e. the mass of the drive shaft, which improves the precision and reliability of movement, in particular axial, of the drive shaft.

According to a particular aspect, the majority of the drive shaft extends inside the frame of the machine tool.

A driving element and a driven element are considered to be in direct engagement when the speed of movement of the driving element is the same as that of the driven element. There is no relative sliding between the elements. An intermediate part may be present but without relative movement between the driving part and the driven part.

### BRIEF DESCRIPTION OF THE DRAWINGS

Other characteristics and advantages of the invention will emerge from the description which follows, which is purely illustrative and not limiting and must be read with reference to the appended drawings, in which:

FIG. 1 is a schematic view of a machine tool carried by a movable support system, such as a robot, for working on a workpiece, according to one embodiment of the invention;

FIG. 2 illustrates a sectional view of a machine tool equipped with a tool which is in contact with a workpiece to be worked, according to one embodiment of the invention;

FIG. 2A illustrates a sectional view of the machine tool of FIG. 2 with a relative axial movement of the workpiece to be worked relative to the machine tool, which results in a relative axial movement of the workpiece to be worked relative to the tool;

FIG. 2B illustrates an axial sectional view of the machine tool of FIG. 2A with an axial movement of the tool obtained by axial movement of the drive shaft of the tool, to compensate for the relative axial movement of the workpiece to be worked relative to the tool;

FIG. 3 is a schematic axial sectional view of a machine tool according to another embodiment;

FIG. 4 is a schematic axial sectional view of a machine tool according to another embodiment;

FIG. 5 is the flowchart of a work method with a work system according to one embodiment.

### DETAILED DESCRIPTION OF PARTICULAR EMBODIMENTS

The concept of the invention is described more fully below with reference to the accompanying drawings, in which embodiments of the concept of the invention are shown. In the drawings, the size and relative sizes of elements may be exaggerated for clarity. Similar numbers refer to similar elements on all drawings. However, this concept of the invention can be implemented in many different forms and should not be construed as being limited to the embodiments disclosed here. Instead, these embodiments are proposed so that this description is complete, and communicates the scope of the concept of the invention to those skilled in the art.

Reference throughout the specification to “one embodiment” means that a particular functionality, structure, or characteristic described in connection with a embodiment is included in at least one embodiment of the present invention. Thus, the appearance of the phrase “in one embodiment” in various locations throughout the specification does not necessarily refer to the same embodiment. Furthermore, the particular functionalities, structures, or characteristics may be combined in any suitable manner in one or several embodiments.

With reference to the figures, a system for working a workpiece P1 is represented. The work system includes a machine tool M1 comprising a frame 100 and, carried by the frame 100, a work assembly which comprises a motorization system 2, 3 and a drive shaft 400.

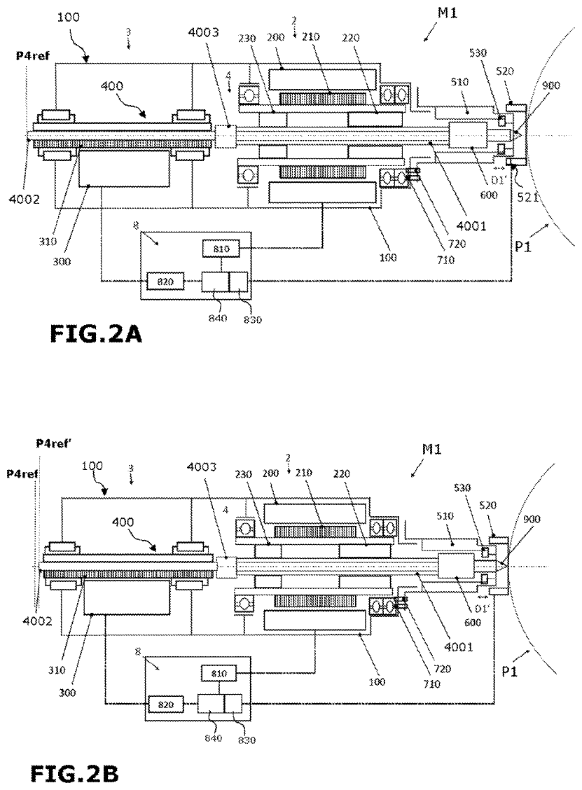

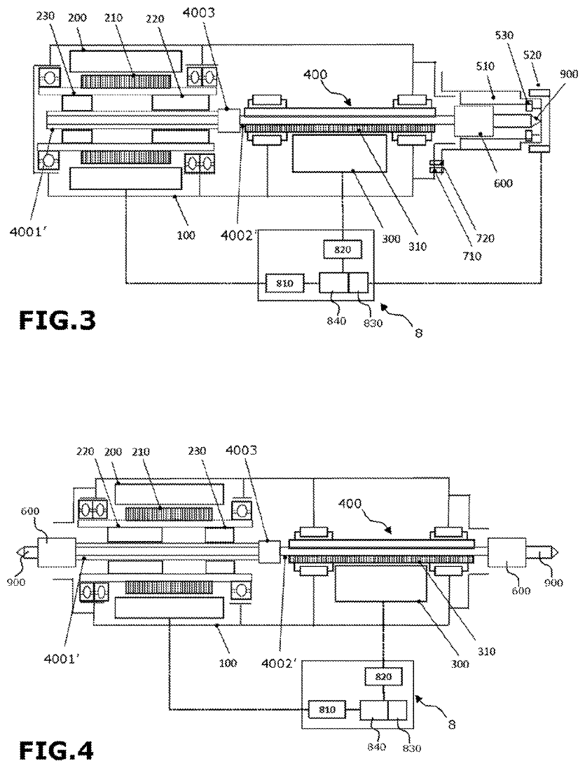

The drive shaft 400 is provided at one end with a tool holder 600 capable of receiving a tool 900 for working on a workpiece P1. In the embodiment illustrated in FIGS. 2, 2A, 2B, only one end of the drive shaft 400 is provided with a tool holder and therefore with a tool. According to other embodiments and as illustrated in FIG. 3, it can be provided that each end of the drive shaft 400 is provided with a tool holder 600 and therefore with a tool 900. The drive shaft 400 is drivable by the motorization system 2.3 itself controllable by a control unit 8 as described below.

The motorization system 2, 3 is configured to make it possible not only to rotate at least one portion 4001 of the drive shaft 400 to which the tool holder 600 is fastened so as to be able to rotate the tool 900 fastened to the tool holder 600 in a removable manner, but also to axially move said portion 4001 of the drive shaft 400 (preferably by axial movement of another portion 4002 of the drive shaft as explained below) to allow the tool holder 600 and therefore the tool 900 coupled to the tool holder to be moved axially.

The fact of having the axis (direction) of thrust, which corresponds to the axis of movement of the drive shaft (also called feed axis), collinear with the axis of the tool allows precise and reliable work on the workpiece.

As detailed below, the machine tool makes it possible to obtain a reliable and precise compensation in real time for the axial position of the drive shaft of the tool holder relative to the workpiece P1, and therefore of the tool, when a relative axial movement of the position of the workpiece to be worked relative to the frame of the machine tool occurs.

The reliability of this compensation results from the decoupling of the rotational movement of the portion of the drive shaft to which the tool holder 600 is fastened from the translation movement applied (directly or indirectly) to said portion of the drive shaft to which the tool holder is fastened.

According to one embodiment and as illustrated in the figures, the drive shaft 400 comprises a first segment 4001 and a second segment 4002 integral with each other in axial movement.

The first segment 4001 to which the tool holder 600 is fastened can be rotated by a first motor 2 presented below. The second segment 4002 can be axially moved by a second motor 3 presented below, and arranged with the first segment 4001 to axially move said first segment 4001, while being independent in rotation of said second segment 4002. The two drive shaft segments are collinear.

In other words, the axial movement of the second segment 4002 which causes the axial movement of the first segment 4001 has no impact on the rotation of the first segment 4001 to which the tool holder 600 is fastened. Conversely the rotation of the first segment 4001 has no impact on the axial positioning of the second segment 4002. This ensures good control of the process parameters by making the control of the rotational and translational movement of the segments of the drive shaft of the tool holder independent of each other, while ensuring thrust in the tool axis, which makes it possible to reliably and precisely obtain the desired final geometry for the workpiece to be worked during work operations, such as drilling and countersinking.

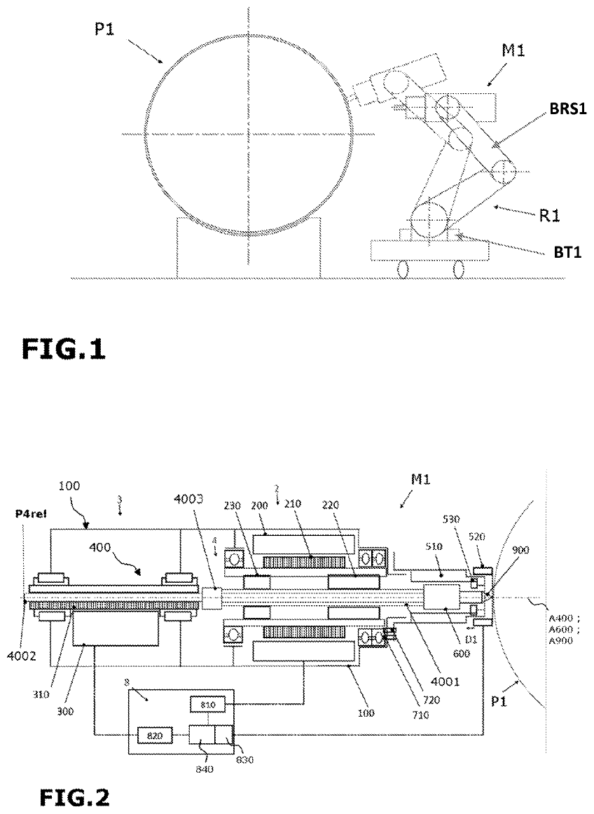

As illustrated in FIG. 1, the machine tool can be carried by a support system R1, such as a polyarticulated robot. The support system R1 can also be a numerically controlled machine or a specific tooling device.

It can be provided that the support system R1 is itself mounted on a carriage system configured to move in several directions relative to the workpiece P1 to be worked. The support system and/or the carriage system makes it possible to position the machine tool and therefore the tool according to the desired position and orientation relative to the workpiece to be worked.

In the example illustrated in FIG. 1, the support system R1 comprises a main base (or framework) BT1 and an arm BRS1. The machine tool M1 is hingedly mounted on the arm BRS1. Said Arm BRS1 comprises one or several sections which can be hinged together. Said arm BRS1 is preferably itself hingedly mounted on the base BT1.

Advantageously, the work system comprises a device for relatively locating the machine M1 with the workpiece to be produced P1 to make it possible, in particular before starting work on the workpiece, to know precisely the position and/or orientation of the machine tool relative to the workpiece P1.

In the example illustrated in FIG. 1, the support system R1 can be moved independently of the workpiece P1. For example, the support system R1 can be positioned so that the machine tool M1 has a position and an orientation as illustrated in FIG. 1 in short dashed lines.

The tool 900 is for example a drilling spindle. The tool 900 has a longitudinal axis A900 coaxial with the axis A400 of the drive shaft 400. The tool holder 600 also has an axis A600 which is coaxial with the axis A400 of the drive shaft 400.

### Motorization System

As mentioned above, the machine tool M1 comprises an electric motorization system which includes a first motor 2, called a rotational drive motor, configured to rotate at least one portion 4001 of the drive shaft 400.

The motorization system also includes a second motor 3, called a feed motor, which makes it possible to axially move said drive shaft 400, preferably in direct engagement with a segment 4002 which is independent in rotation of the segment 4001 which carries the tool 900 through the tool holder 600. In other words, the feed motor 3 makes it possible to control the translation of the drive shaft along its longitudinal axis A400 without impact on the rotation of said shaft.

The rotational drive motor 2 is mounted integral in rotation with the segment 4001 of the drive shaft 400 provided with the tool holder 600 for its rotational drive, while being in sliding connection with said segment 4001, to authorize an axial movement of said segment 4001 controlled by the feed motor 3.

The rotational drive motor 2 and the feed motor 3 are able to be controlled independently of each other. As recalled above, each motor can, under the control of the control unit 8, act on the drive shaft 400 independently of the action of the other motor on said shaft: One of the motors controls only the rotation of the shaft and the other only its axial movement. As explained below, the two motors act respectively on two collinear segments of the drive shaft, which makes it possible not to generate a geometric defect at the tip of the tool 900 fastened to the tool holder when the latter rotates.

Preferably, the axis of rotation of the rotational drive motor 2 is coaxial with the axis of the feed motor 3.

### Drive Shaft

As recalled above, in the embodiment illustrated in FIGS. 1 and 2, the drive shaft 400 comprises a first segment 4001 which can be rotated by the motor 2 and at one end of which the tool holder 600 is fastened, and a second segment 4002 which can be axially moved by the feed motor 3, so as to be able to push or pull axially on the first segment 4001 to axially move the tool 900 associated with the first segment 4001 by the tool holder.

The connection 4003 between the first segment 4001 and the second segment 4002 is configured so that the first segment 4001 and the second segment 4002 are integral in axial movement with each other, while maintaining freedom of rotation of the second segment 4002 relative to the first segment 4001.

The connection 4003 can thus be made in the form of a pivot connection, with a pivot axis coaxial with the axis A400 of the drive shaft 400. Optionally, the connection 4003 can be made in the form of a ball joint.

Such a design of the machine makes it possible to obtain independence of action of a motor on the drive shaft in relation to the action of the other motor on said drive shaft.

Thus, the rotation of the tool 900 and its axial position relative to the frame of the machine can be controlled independently of each other and therefore in a reliable and precise manner.

The connecting device 4003 between the two segments 4001, 4002, is devoid of axial clearance, and allows the second segment 4002 to be left free to rotate relative to the first segment 4001.

This compact architecture makes it possible to provide a thrust on the tool 900 in the axis of the drive shaft (spindle axis), as well as decoupling the control of the two motors.

Such a design facilitates the realization of control and monitoring loops such as for example drilling cycles with discontinuous cutting allowing the fragmentation of the chip which thus facilitates its evacuation during the operation.

In the variant of FIG. 3 (or FIG. 4), the segment 4002′ which is fitted with the tool holder is engaged with the feed motor 3, and the other segment 4001′ is engaged with the rotational drive motor 2. The segment 4002′ controllable in axial movement by the feed motor 3, thus extends between the tool 900 and the segment 4001′ controllable in rotation by the motor 2. In this case the connection 4003 is a rigid connection so that that the segments 4001′, 4002′ are integral in axial movement and in rotation.

The segment of the drive shaft 400 which is engaged with the feed motor 3 is distinct from the segment of the drive shaft 400 which is engaged with the rotational drive motor 2.

According to one embodiment, the two segments of the shaft of the machine tool M1 are drilled, preferably axially in their center, in order to allow a refrigerant liquid to pass for the drilling operations.

### Rotary Motor

The rotary motor 2 corresponds to a spindle motor which rotates the first segment 4001 of the drive shaft 400 which carries the tool 900. The rotary motor 2 comprises a stator 200 fixed relative to the frame 100 of the machine M1 and a rotor 210 whose rotation speed is controllable by a control module 810 of the control unit 8 as explained below.

According to one embodiment, the first segment 4001 of the drive shaft 400 is a splined segment rotationally coupled to the rotor 210 of the motor 2 by a meshing system integral with the rotor 210 which cooperates with the splined segment.

Preferably, the meshing system comprises a main meshing member 220 and a secondary meshing member 230 spaced apart axially in order to distribute the driving torque, and increase the stiffness of the assembly and improve the precision of the rotation of the first segment 4001 thanks to a longer guidance of said first segment.

Preferably the stator of the rotation motor comprises a winding system and the rotor comprises a magnet system so that the electrical powering of the winding system generates a magnetic field which interacts with the magnet system. The rotary motor thus generates a radial electromotive force (electromagnetic torque) which rotates at least the portion of the drive shaft with which the rotor is engaged.

### Feed Motor

Preferably, the feed motor 3 is a linear motor configured to control the axial movement of the second segment 4002. The use of a linear motor makes it possible to axially move the second segment 4002 and thus the first segment 4001 linked axially to the first segment, without rotating or adding rotational movement to the second segment 4002.

As illustrated in the figures, the feed motor 3 comprises a primary 300 and a secondary 310.

The primary 300 is fixed relative to the frame 100 of the machine M1 and the secondary 310, which is fastened to or integrated into the drive shaft 400, is movable in translation relative to the primary 300 in a direction parallel to the axis of the drive shaft 400. According to a particular embodiment, it can be provided that the primary 300 and the secondary 310 of the feed module respectively comprise several primaries and several secondaries. The feed motor generates an axial electromotive force (with an axis parallel to the axis of the drive shaft) which translates the drive shaft with which the secondary of the feed motor is engaged.

According to one embodiment of the invention, the primary part of the feed motor comprises a winding system carried by the frame and electrically powered, and the secondary part 310 comprises a magnet system. The secondary of the feed motor comprises a magnet system which is carried by a part integral with the drive shaft or which is directly integrated into the drive shaft. The electric powering of the winding system generates a magnetic field which interacts with the magnet system.

The fact of carrying the magnet system by the drive shaft and the winding system, which is heavier than the magnet system, by the frame, makes it possible not only to facilitate the wiring for the powering of the corresponding motor, but also to limit the mass to be moved, i.e. the mass of the drive shaft, which improves the precision and reliability of movement, in particular axial, of the drive shaft. The distribution of the winding system and the magnet system could be reversed, but would be less advantageous.

The powering of the winding system of the feed motor can be carried out so as to move the magnetic field created along the axis of the drive shaft at a given speed. Preferably, a control unit makes it possible to control the speed of movement of the magnetic field generated according to the desired movement speed to control the axial movement speed of the drive shaft.

As detailed below, the movement of the drive shaft to obtain a new reference position P4ref of the drive shaft, relative to the frame of the machine tool, in order to compensate for the movement of the workpiece to be worked, is obtained by controlling a single motor which is the feed motor.

In the example illustrated in FIGS. 1 and 2, the secondary 310 is mounted integral in translation with the segment 4002 in a direction parallel to the axis of the segment 4002 (which also corresponds to the axis of the segment 4001 of the drive shaft 400). The axial movement of the secondary 310 is controllable by a control module 820 of the control unit 8.

The axial movement of the secondary 310 of the motor 3 causes the axial movement of the second segment 4002 of the drive shaft. The secondary 310 of the motor 3 and the second segment 4002 can be made in one and the same piece.

As explained below, the feed motor 3 makes it possible to move the drive shaft 400 to compensate for a relative axial movement of the frame 100 of the machine M1 with the workpiece P1 (FIGS. 2, 2A, 2B).

Compared to a complete movement of the machine M1, the fact—to compensate for a relative axial movement of the workpiece P1 relative to the frame 100 of the machine—of simply axially moving the drive shaft 400 relative to the frame 100 of the machine by moving the secondary 310 of the feed motor 3 which is coupled to the segment 4002 of the drive shaft 400, makes it possible to limit the size of the feed motor 3 and therefore to limit the size (overall dimensions and mass) of the machine M1. Limiting the moving mass makes it possible to increase the mechanical bandwidth of the system.

In other words, the fact of being able, during the work operation on the workpiece P1, in the event of detection of a relative axial movement between the workpiece P1 and the frame 100 of the machine, to axially move the tool 900 by movement of the secondary 310 of the feed motor relative to the primary 300 of the feed motor 3 and therefore relative to the frame 100 of the machine, allows not having to move the entire machine tool to perform an axial correction of relative axial movement between the workpiece and the frame of the machine during the work operation on the workpiece.

Of course, when the machine tool is positioned on a moving system such as the support system R1, preferably itself carried by a carriage system, the entire machine remains movable relative to the workpiece to previously position and/or orient the tool 900 as a function of the work on the workpiece to be performed.

The motor 3 manages the feed of the second segment 4002 of the drive shaft by a direct translational drive, i.e. an axial movement of the second segment 4002 and therefore of the tool 900.

The fact of having a direct transmission of movement between the feed motor 3 and the second segment 4002 of the drive shaft without a reduction gear such as a helical nut, allows, on the one hand, to have good efficiency, and, on the other hand, to have direct and therefore non-noisy force feedback information.

Such a design of the machine thus makes it possible to control the rotation of the tool 900 using the rotary motor 2 independently of the axial movement of the tool which is controllable using the feed motor 3.

The independence of the rotation of the first segment 4001 relative to its axial movement makes it possible to realize control and monitoring loops, such as for example drilling cycles with discontinuous cutting allowing the fragmentation of the chip which thus facilitates its evacuation during the operation.

To compensate for the movement of the workpiece, the axial movement of the drive shaft is made while maintaining the frame of the machine tool which carries the motors, stationary in the terrestrial reference frame. It is therefore the drive shaft which moves, preferably along and inside the frame of the machine tool, and not the frame which would be moved in the terrestrial reference frame.

According to a particular aspect, the majority of the drive shaft extends inside the frame of the machine tool.

Advantageously, the secondary of the feed motor is in direct engagement with said drive shaft. A driving element and a driven element are considered to be in direct engagement when the speed of movement of the driving element is the same as that of the driven element. There is no relative sliding between the elements. An intermediate part may be present but without relative movement between the driving part and the driven part.

### Distance Determination System

The machine tool comprises a distance measuring device 521 configured to, in particular during work on the workpiece P1 by the tool 900, measure a distance representative of the distance between the workpiece P1 and the frame 100 of the machine.

The distance measuring device 521 is connected to the control unit 8 which is configured to determine, using a distance change determination module 830, a change in the axial distance between the frame 100 of the machine tool and the workpiece P1 to be worked.

As explained below, when the module 830 determines that the distance D1 between the frame 100 of the machine tool and the workpiece P1 to be worked has been changed into a distance D1′, for example when the distance difference D1-D1′ is greater than a threshold value, then the module 840 controls the axial movement of the drive shaft 400 for a change of the axial reference position P4ref of the shaft 400 to compensate for this relative change in the distance between the workpiece P1 and the frame 100 of the machine. The axial reference position of the drive shaft is memorized by the control unit 8 to enable the work instructions on the workpiece to be executed, which include commands for axial (and rotational) movement of the shaft 400 and therefore of the tool 900, as a function of said axial reference position of the drive shaft.

### Control Unit

As recalled above, the control unit 8 comprises a rotation control module 810 making it possible to control the rotation speed of the rotational drive motor 2. The rotation control module 810 is preferably configured to allow a constant rotation speed of the motor 2 and therefore of the tool to be held, while allowing the speed of the tool to be varied as required.

The control unit 8 also comprises a feed control module 820 making it possible to control the feed motor 3 to control the axial movement of the second segment 4002 and therefore of the first segment 4001 fitted with the tool holder 600.

The machine tool comprises a sensor for the position of the segment 4002 which is engaged with the feed motor 3. Said position sensor is connected to the control unit 8 to allow the control unit to know precisely the position of the segment, and make it possible to modify in real time the amplitude of the waveform of the feed movement.

Advantageously, the feed control module 820 is configured to make it possible to control an axial movement at constant speed of the second segment 4002.

Preferably, the feed control module 820 can also be configured to control a main axial movement of the second segment 4002 with oscillations superimposed on the main axial movement.

The control unit makes it possible to control the rotational drive motor 2 and the feed motor 3 independently of each other, while allowing them to be controlled simultaneously.

The control unit 8 comprises a control module 840 which is configured to, following a change in the distance determined by the module 830 between the frame 100 of the machine tool M1 and the workpiece P1 to be worked, control the feed motor 3 to axially move said drive shaft by a distance equal to the determined change in the distance. The drive shaft then has a new axial reference position P4ref according to which the work instructions on the workpiece P1 can continue to be executed, which makes it possible to compensate for the relative axial movement of the workpiece P1 relative to the frame of the machine M1.

Thus, in the case where there is a relative axial movement between the frame 100 of the machine tool M1 and the workpiece P1 to be manufactured of a given value, the machine thus makes it possible to compensate by the same value, and this in real time, for the axial position of the shaft 400 and therefore of the tool 900.

It can be provided that the machine tool includes an interface making it possible to select one or several oscillation parameters (frequency and/or amplitude) and/or the shape of the signal (sine, triangle, trapezoid, etc.).

It can be provided that these parameters can be selected according to given criteria such as the hardness of the material and can be changed in real time in order to promote chip fragmentation. It can also be provided that the oscillation parameters can be automatically defined or changed by a module of the control unit of the machine according to the results of a work test phase on the material to be worked.

According to one embodiment, the control unit 8 is configured to change in real time the setting provided to each of the control modules 810 and 820, as a function of data relating to the current consumed by the feed motor 3, and of data provided by the system for determining the variation in the distance between the machine M1 and the workpiece P1.

According to one embodiment, the variation in the distance between the machine tool M1 and the workpiece P1 to be manufactured can be measured using a distance sensor 521 configured to measure the distance between a bearing device, called a blank holder nose, mounted at the tip of the machine nose on a part of the machine, i.e. at the end of the machine where the tool is located, which comprises a part 520 intended to bear against the workpiece P1 to be worked and a part 510 of the frame 100 of the machine relative to which the part 520 is movable in a direction parallel to the axis of the drive shaft. It can also be provided that the distance variation is provided by the distance measuring sensor 521 which is mounted on the part 510.

The part 520 has a through opening for the passage of the work tool. The part 520 is mounted axially movable relative to the frame for example by a return spring to allow it to bear back against the workpiece to be worked so that a relative axial movement between the workpiece to be worked and the frame of the machine in the direction away from the workpiece P1 results in an axial spacing of the part 520 of the blank holder system relative to the part 510 associated with the frame of the machine.

Alternatively, the blank holder system can be mounted on a support external to the machine tool, and fixed relative to said machine tool. The blank holder system maintains a fixed part 510 and a movable part 520 itself in contact with the workpiece P1 to be manufactured with at least one distance sensor in order to measure a relative axial movement between the two parts 520, 510.

Preferably, the work system comprises a device for measuring the orthogonality of the tool (or of the axis of the drive shaft 400) of the machine M1 with the workpiece P1.

In FIG. 2, the blank holder nose is initially bearing on the workpiece P1 so that the distance between the part 520 of the blank holder nose and the part 510 fastened to the frame 100 is equal to D1.

FIG. 2A illustrates the case where, during the work on the workpiece P1, said workpiece P1 moves back relative to the frame of the machine: the movable part 520 of the blank holder nose which bears back against the workpiece, is then moved away from the frame 100 by a distance D1′. In particular, FIGS. 2, 2A, then 2B show a relative movement between the machine tool M1 and the workpiece P1 to be made and the associated compensation at the machine axis in order to keep the tool 900 in real time in the same position relative to said workpiece P1.

The distance change determination system thus determines that the workpiece P1 has moved axially by a distance D1-D1′.

The compensation module 840 of the control unit 8 controls the axial movement of the drive shaft, here to feed it, by a distance equal to D1-D1′ to compensate for the back movement of the workpiece relative to the frame, so that the reference position P4ref (original position) of the shaft 400, defined for example as being the position of the free end of the segment 4002 relative to the frame 100 is changed into a position P4ref′, with a distance between said reference positions P4ref′ and P4ref equal to the distance D1-D1′.

Thus, as visible in FIG. 2B, the position of the drive shaft 400 (machine axis) relative to the workpiece P1 is compensated for the value of the relative axial movement between the workpiece P1 and the frame of the machine, that is to say the value D1′-D1, and the position of the drive shaft relative to the frame has been fed (in the direction of the workpiece P1) by the distance D1-D1′.

According to one embodiment, the module 830 of the control unit 8 is configured to analyze in real time the data from the two control modules 810 and 820, in order to deduce the relative position of the tool 900 with the workpiece P1, before the tool is inside this workpiece.

It can also be provided that the module 830 of the control unit 8 analyzes in real time the data from the two control modules 810 and 820, in order to deduce the relative position of the cutting tool 900 relative to a change of material in the workpiece P1 to be machined and thus adapt the cutting parameters in real time to the material to be machined according to the adopted strategy.

It can also be provided that the module 830 of the control unit 8 analyzes in real time the data from the two control modules 810 and 820, to determine the wear rate of the tool 900.

### Method

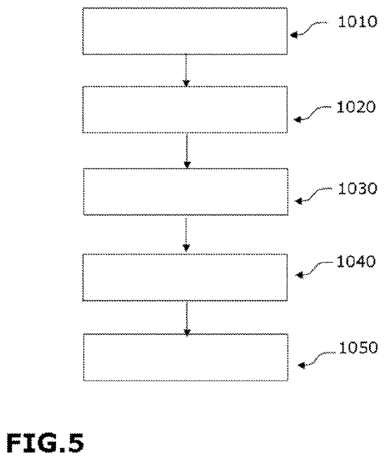

The system presented above makes it possible to implement a method for working a workpiece using a machine tool M1 whose tool holder 600 is provided with a tool 900 as described above. An example of the method is presented below in conjunction with FIG. 5.

The method comprises the following steps. In step 1010, the machine tool M1 is positioned relative to the workpiece P1 in order to be able to work on the workpiece P1 using the tool 900 (by rotation and/or axial movement of the tool 900 relative to the workpiece P1).

The distance between the workpiece P1 and the frame 100 of the machine tool M1 is equal to a value D1, called an initial value. The drive shaft 400 has an axial reference position P4ref relative to the frame 100 of the machine tool. The axial reference position is represented in FIG. 2 as the position of the end of the drive shaft 400 opposite the tool, but said axial reference position can be associated with another portion of the drive shaft 400.

Said axial reference position P4ref is memorized by the control unit 8.

In step 1020, work operations on the workpiece P1 are executed 1020 by controlling the rotational drive motor 2 to rotate the tool 900, and/or by controlling the feed motor 3 to axially move the tool 900 relative to the workpiece P1.

For the work on the workpiece to be performed, the axial movement of the tool 900 is controlled as a function of said axial reference position P4ref of the drive shaft.

In step 1030, during work on the workpiece P1, the control unit determines whether the distance between the workpiece P1 and the frame of the machine has changed.

If not, the work operations on the workpiece P1 continue to be executed (step 1020) without additional intervention on the drive shaft.

If yes, i.e. in the event of determination 1030 of a change in the distance D1′ between the workpiece P1 and the frame 100 of the machine, the distance D1 between the workpiece P1 and the frame 100 of the machine tool M1 is equal to a new value D1′.

The module 840 of the control unit then controls in step 1040, to compensate for the movement of the workpiece P1, the axial movement, relative to the frame of the machine tool, of the drive shaft 400 of the tool holder 600 by a distance, referred to as a compensation distance, corresponding to the difference between the new value D1′ and the initial value D1. The axial reference position of the drive shaft 400 is then changed into a new axial reference position P4ref′ which is recorded by the control unit 8. This new axial reference position P4ref′ corresponds to the previous axial reference position P4ref added with said compensation distance.

In step 1050, the work operations on the workpiece P1 continue to be executed as a function of the new reference position P4ref′ of the shaft.

The possibility of controlling the axial movement of the drive shaft during operation of the machine tool makes it possible to correct the position of the tool and thus hold the relative position of the tool relative to the workpiece to be worked, even in the event of relative axial movement between the workpiece to be worked and the machine tool.

The control unit 8 is for example in the form of a processor and a data memory in which computer instructions executable by said processor are stored, or even in the form of a microcontroller.

In other words, the described functions and steps can be implemented in the form of a computer program or via hardware components (e.g. programmable gate networks). In particular, the functions and steps operated by the control unit, in particular for controlling the motors, can be made by sets of instructions or computer modules implemented in a processor or controller or be made by dedicated electronic components or components of field-programmable gate array (FPGA) type or application-specific integrated circuit (or ASIC) type. It is also possible to combine computer parts and electronic parts.

The control unit is thus an electronic and/or computer unit. When it is specified that said unit is configured to carry out a given operation, this means that the unit comprises computer instructions and the corresponding execution means which make it possible to carry out said operation and/or that the unit comprises corresponding electronic components.

The machine tool thus makes it possible to determine a possible relative axial movement between the frame 100 of the machine tool M1 and the workpiece P1 to be manufactured and to correct, in real time, this relative axial movement during the work operation on the workpiece.

The fact of having a decoupling of the two motors, with in particular a rotation of the first segment controlled by the rotary motor 2, which is independent of the axial movement of the second segment controllable by the second motor 3, makes it possible not to generate a geometric defect at the tip of the tool 900 during its rotation.

Indeed, the decoupling between the motors makes it possible to hold the orientation of the interface between the tool holder 600 and the segment of the shaft 4000 provided with the tool holder, the interface being in a reference plane which is perpendicular to the machine axis so as not to generate a geometric defect at the tip of the tool 900 during its rotation.

This correction makes it possible to carry out a precise work on the workpiece, in particular for countersinking operations, due to the fact that the countersink must generally be positioned very precisely relative to the surface of the workpiece P1.

Advantageously, the system can comprise an optical device making it possible to measure the quality of the work carried out on the workpiece P1.

### Applications

The machine tool can be a machine adapted to carry out different operations such as milling, trimming, drilling, threading and nut tightening operations. The tool fitted to the machine is then adapted to carry out said operation.

As recalled previously, the machine tool can be embedded on a numerically controlled machine or on a robot, or on a tooling system.

According to one embodiment, the machine tool comprises a system for measuring the current consumed by the feed motor, and the control unit is configured to adapt the work process, such as the choice of an automatic change of cutting parameters when drilling a multi-material assembly taking into account the type of material being drilled and the second material to be drilled.

According to one embodiment, the machine tool comprises a coupling interface of the blank holder nose configured to be able to change the blank holder nose, preferably automatically, depending on the workpiece to be worked. This interface comprises centering and plane bearing to ensure positioning repeatability. Preferably, this interface also includes pneumatic and electrical connections usable among other things for blank holder functions, distance and orthogonality measurements of the machine M1 relative to the workpiece P1 to be worked.

The nose can be a blank holder nose (or a blank holder) as shown in FIG. 2, a concentric collar-version nose or a quarter turn-version nose.

The blank holder nose can be used in automated applications involving means for positioning the machine tool such as a robot or a numerically controlled machine. The machine tool M1 can also be used in a portable version. Of course, the machine can be used without a nose for particular applications.

According to a particular aspect, in the case of using a nose, inner guidance of the tool holder is provided inside the nose in particular in order to limit the possible modes of vibration.

According to one embodiment, the nose can thus include an inner element for guiding the tool holder as well as a blocking element 530, called a blocker, to block the rotation of said tool holder making it possible to screw or unscrew the tool holder on the first segment 4001 of the shaft.

The tool holder is fastened on the first segment of the drive shaft by screwing said tool holder onto the first segment of the drive shaft. The blocker can be used for the mounting or dismounting of the tool holder relative to the drive shaft by blocking the tool holder on this blocker by cooperation of male and female shape to proceed with the screwing or unscrewing of said tool holder relative to the drive shaft.

According to one embodiment, the machine includes electrical 710 and pneumatic 720 connections making it possible to automatically connect and disconnect the machine nose with the machine.

The invention is not limited to the embodiments illustrated in the drawings. Consequently, it must be understood that, when the characteristics mentioned in the appended claims are followed by reference signs, these signs are included solely for the purpose of improving the intelligibility of the claims and are in no way limiting the scope of the claims.

Furthermore, the term “comprising” does not exclude other elements or steps. Furthermore, features or steps that have been described with reference to one of the embodiments disclosed above may also be used in combination with other features or steps of other embodiments disclosed above.

1. A system for working a workpiece, the system comprising a machine tool which comprises:
a frame;
a drive shaft having a longitudinal axis, the drive shaft being provided with a tool holder to which a tool can be coupled;
a first motor, called a rotational drive motor, which is a rotary motor configured to rotate at least one portion of the drive shaft, the at least one portion of the drive shaft being fitted with the tool holder;
a second motor, called a feed motor, the feed motor being configured to axially move the drive shaft relative to the frame of the machine tool;
a distance measuring device configured to measure a distance representative of a distance between the workpiece and the frame of the machine tool; and
a control unit configured to:
execute work operations on the workpiece by controlling the rotational drive motor to rotate the tool holder, and/or by controlling the feed motor to axially move the tool holder;
determine, using the distance measuring device, a change in the axial distance between the frame of the machine tool and the workpiece to be worked resulting from a relative axial movement between the workpiece and the frame of the machine;
depending on the change in the distance determined between the machine tool and the workpiece to be worked, control the second motor to axially move the drive shaft relative to the frame of the machine tool to compensate for the relative axial movement between the workpiece and the frame of the machine;
wherein the rotational drive motor and the feed motor are configured so that the axial movement of the at least one portion of the drive shaft which is fitted with the tool holder is controllable independently of the rotation of the at least one portion of the drive shaft which is fitted with the holder tool.

2. The system according to claim 1, wherein the feed motor is a linear motor having a primary part fixedly mounted relative to the frame of the machine tool, and a secondary part, movably mounted, relative to the primary part, in a direction parallel to the axis of the drive shaft, the secondary part being fastened to a segment of the shaft drive, or formed integrally with the segment of the drive shaft.

3. The system according to claim 2, wherein the secondary part comprises a magnet system and the primary part of the feed motor comprises an electrically powered winding system for, in a powered state, create a magnetic field which interacts with the magnet system in order to generate an electromotive force with an axis parallel to the axis of the drive shaft.

4. The system according to claim 1, wherein the distance measuring device is carried by a movable part of a bearing device, called a blank holder nose, the movable part of the blank holder nose being movably mounted relative to a part which is fixed relative to the frame, the movable part being configured to bear back against the workpiece, the distance measuring device being arranged to measure a distance between the movable part and the fixed part of the blank holder nose.

5. The system according to claim 1, wherein the drive shaft comprises a first segment and a second segment connected together by a connecting device, one of the first and second segments being engaged with the feed motor, the other of the first and second segments being engaged with the rotational drive motor.

6. The system according to claim 1, wherein the drive shaft comprises a first segment and a second segment connected together by a connecting device configured to make the first segment and the second segment integral in axial movement with each other, while maintaining freedom of rotation of the first segment relative to the second segment.

7. The system according to claim 5, wherein the first segment to which the tool holder is fastened can be rotated by the rotational drive motor, and the second segment can be axially moved by the feed motor.

8. The system according to claim 1, wherein the system comprises a support system which carries the machine tool to allow the machine tool to be positioned at a desired position and a desired orientation relative to the workpiece to be worked, the machine tool being hingedly mounted to the support system.

9. The system according to claim 8, wherein the support system comprises a main base and an arm, the machine tool being hingedly mounted on the arm, the arm comprising one or several sections which can be hinged together.

10. The system according to claim 1, wherein the control unit is configured to allow the drive shaft to be moved in order to move the tool axially in a movement with variable speed to fragment a chip resulting from a work of the tool on the workpiece to be worked.

11. A method for working a workpiece using a work system according to claim 1, the machine tool of the tool holder of the work system being equipped with the work tool, the method comprising:
positioning the machine tool relative to the workpiece with a view to working the workpiece using the tool; the distance between the workpiece and the frame of the machine tool being equal to a value, called an initial value, the drive shaft having an axial reference position relative to the frame of the machine tool;
executing work operations on the workpiece by controlling the rotational drive motor to rotate the tool, and/or by controlling the feed motor to axially move the tool;
the axial movement of the tool being controlled as a function of the axial reference position of the drive shaft;
during work on the workpiece, determining a change in the distance between the workpiece and the frame of the machine, so that the distance between the workpiece and the frame of the machine tool is equal to a new value;
compensating for the movement of the workpiece by axial movement of the drive shaft of the tool holder by a distance, referred to as a compensation distance, corresponding to a difference between the new value and the initial value so as to define a new axial reference position of the drive shaft, and
continuing work operations on the workpiece as a function of the new reference position of the shaft.

12. The system according to claim 1, wherein the tool coupled to the tool holder is a drilling spindle.

13. The system according to claim 8, wherein the support system is a polyarticulated robot.

14. The system according to claim 9, wherein the arm is hingedly mounted on the base.

15. The system according to claim 2, wherein the distance measuring device is carried by a movable part of a bearing device, called a blank holder nose, the movable part of the blank holder nose being movably mounted relative to a part which is fixed relative to the frame, the movable part being configured to bear back against the workpiece, the distance measuring device being arranged to measure a distance between the movable part and the fixed part of the blank holder nose.

16. The system according to claim 3, wherein the distance measuring device is carried by a movable part of a bearing device, called a blank holder nose, the movable part of the blank holder nose being movably mounted relative to a part which is fixed relative to the frame, the movable part being configured to bear back against the workpiece, the distance measuring device being arranged to measure a distance between the movable part and the fixed part of the blank holder nose.

17. The system according to claim 2, wherein the drive shaft comprises a first segment and a second segment connected together by a connecting device, one of the first and second segments being engaged with the feed motor, the other of the first and second segments being engaged with the rotational drive motor.

18. The system according to claim 3, wherein the drive shaft comprises a first segment and a second segment connected together by a connecting device, one of the first and second segments being engaged with the feed motor, the other of the first and second segments being engaged with the rotational drive motor.

19. The system according to claim 4, wherein the drive shaft comprises a first segment and a second segment connected together by a connecting device, one of the first and second segments being engaged with the feed motor, the other of the first and second segments being engaged with the rotational drive motor.

20. The system according to claim 2, wherein the drive shaft comprises a first segment and a second segment connected together by a connecting device configured to make the first segment and the second segment integral in axial movement with each other, while maintaining freedom of rotation of the first segment relative to the second segment.
